(19) United States
(12) Patent Application Publication
(10) Pub. No.: US 2018/0347670 A1
(43) Pub. Date: Dec. 6, 2018

(54) DUAL-CLUTCH TRANSMISSION

(71) Applicant: ISUZU MOTORS LIMITED, Shinagawa-ku, Tokyo (JP)

(72) Inventor: Hidetoshi UJI, Yokohama-shi, Kanagawa (JP)

(21) Appl. No.: 15/775,365

(22) PCT Filed: Nov. 9, 2016
(86) PCT No.: PCT/JP2016/083188

§ 371 Date: May 10, 2018

(30) Foreign Application Priority Data
Nov. 12, 2015 (JP) 2015-222047

(51) Int. Cl. F16H 3/091; F16H 3/00

(52) U.S. Cl. CPC F16H 3/091; F16H 2200/0056; F16H 3/006

(57) ABSTRACT

Provided is a dual-clutch transmission, including a dual-clutch device 20; a first primary gear train 41 for transmitting power from a first input shaft 31 to a subsidiary shaft 34; a second primary gear train 42 for transmitting power from a second input shaft 32 to the subsidiary shaft 34; a plurality of output gear trains 51 to 53 rotatably provided on an output shaft 33; and a synchronization mechanism 60 for synchronously joining the output gear trains 51 to 53. Step ratios upon gear shifts performed by only clutch change are set to be smaller than step ratios upon gear shifts performed by both clutch change and gear change.

### TECHNICAL FIELD

The present disclosure relates to a dual-clutch transmission.

### BACKGROUND ART

Conventionally, dual-clutch transmissions have been put to practical use, in which a dual-clutch device having two clutches is provided between an engine and a transmission and thus transmitting power from the engine to the transmission can be switched between two lines (e.g., see Patent Document 1).

In such dual-clutch transmissions, for example, when upshifting from a first gear-shift stage to a second gear-shift stage, only clutch change is performed while a ½ stage gear is synchronously joined, whereas when upshifting from the second gear-shift stage to a third gear-shift stage, clutch change is performed, and at the same time the ½ stage gear is disconnected and a ¾ stage gear is synchronously joined.

### CITATION LIST

### Patent Document

Patent Document 1: JP-A-2013-245818

### SUMMARY OF THE INVENTION

### Problem that the Invention is to Solve

In general, in the dual-clutch transmissions, a gear ratio of a splitter is set such that step ratios upon gear shifts (ratios of increase in gear ratio upon upshifting a gear-shift stage by one stage) are approximately the same. Therefore, a time required for gear shifts performed by both clutch change and gear change is longer than a time required for gear shifts performed by only clutch change due to an influence of rotational synchronous joining. There is a problem that a sense of incompatibility is given to a driver, thereby worsening the gear-shift feeling.

An object of the technique of the present disclosure is to suppress unevenness in time required for gear shifts, thereby effectively reducing a sense of incompatibility, which would have been given to a driver.

### Means for Solving the Problems

The technique of the present disclosure is a dual-clutch transmission, including: a clutch device having first and second clutches capable of connecting or disconnecting power from a driving source; a first input shaft connected to the first clutch; a second input shaft connected to the second clutch; a subsidiary shaft arranged parallel to the first and second input shafts; an output shaft arranged parallel to the subsidiary shaft; a first primary gear train that transmits power from the first input shaft to the subsidiary shaft; a secondary primary gear train that transmits power from the second input shaft to the subsidiary shaft; a plurality of output gear trains rotatably provided on at least one of the subsidiary shaft or the output shaft; and a synchronization mechanism for synchronously joining the output gear trains; wherein a first gear-shift stage is set when the first clutch is in a connecting state and the second clutch is in a disconnecting state by the clutch device in a state where one of the output gear trains is synchronously joined by the synchronization mechanism, wherein an upshifting to a second gear-shift stage, which is one stage higher than the first gear-shift stage, is performed when the first clutch is changed to a disconnecting state and the second clutch is changed to a connecting state by the clutch device in a state where the one of the output gear trains is synchronously joined by the synchronization mechanism, wherein an upshifting to a third gear-shift stage, which is one stage higher than the second gear-shift stage, is performed when the first clutch is changed to the connecting state and the second clutch is changed to the disconnecting state by the clutch device in a state where another output gear train different from the one of the output gear trains is synchronously joined by the synchronization mechanism, and wherein a step ratio upon gear shift from the second gear-shift stage to the third gear-shift stage is set to be smaller than a step ratio upon gear shift from the first gear-shift stage to the second gear-shift stage.

Preferably, an interstage ratio obtained by dividing a gear ratio of the first primary gear train by a gear ratio of the second primary gear train is set to be larger than an interstage ratio which causes step ratios upon gear shifts to become the same.

### Effects of the Invention

According to the technique of the present disclosure, it is possible to suppress unevenness in time required for gear shifts, thereby effectively reducing a sense of incompatibility, which would have been given to a driver.

### BRIEF DESCRIPTION OF DRAWINGS

FIG. 1 is a schematic overall configuration diagram showing a dual-clutch automatic transmission according to one embodiment of the present disclosure.

FIG. 2 is a view explaining upshifting depending on a vehicle speed and a rotation speed of an engine by a dual-clutch automatic transmission according to a first embodiment of the present disclosure.

FIG. 3 is a view explaining upshifting depending on a vehicle speed and a rotation speed of an engine by a dual-clutch automatic transmission according to a conventional example.

### MODE FOR CARRYING OUT THE INVENTION

Hereinafter, a dual-clutch automatic transmission according to one embodiment of the present disclosure will be described with reference to the accompanying drawings. The same components are designated by the same reference numerals, and the names and functions thereof are the same. Therefore, the detailed descriptions thereof will be not repeated.

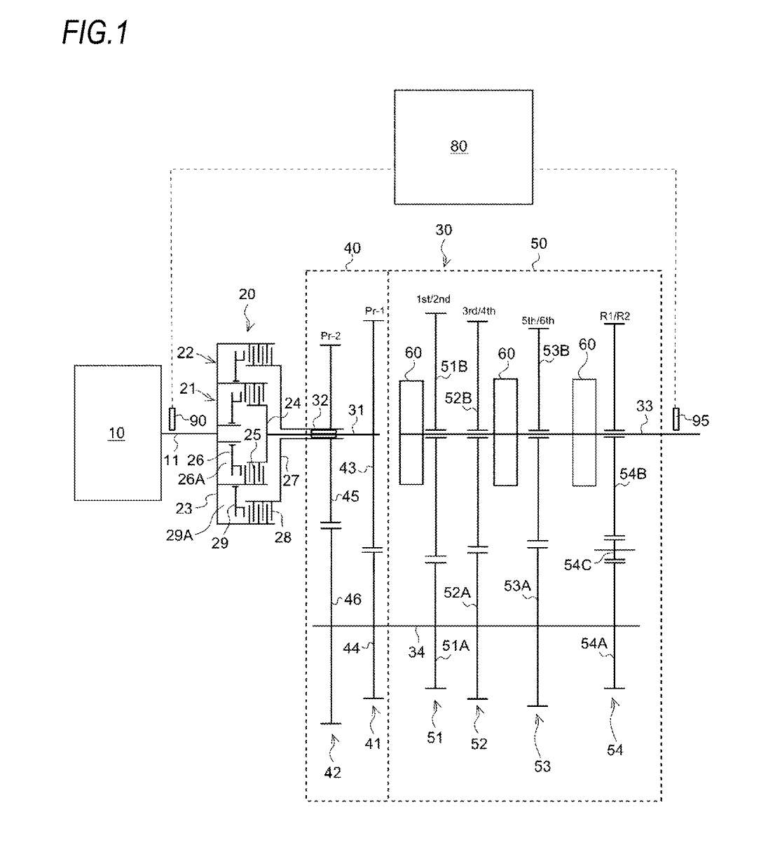

FIG. 1 is a schematic overall configuration diagram showing a dual-clutch automatic transmission according to the present embodiment. In FIG. 1, a reference numeral 10 refers to an engine, which is a driving source, a reference numeral 80 refers to a control unit, a reference numeral 90 refers to a sensor of the rotation speed of the engine, and a reference numeral 95 refers to a vehicle speed sensor.

The dual-clutch automatic transmission includes a dual-clutch device 20 having a first and second clutches 21, 22, and a transmission mechanism 30.

The first clutch 21 is, for example, a wet multi-plate clutch and includes a clutch hub 23 integrally rotating with an output shaft 11 of an engine 10, a first clutch drum 24 integrally rotating with a first input shaft 31 of the transmission mechanism 30, a plurality of first clutch plates 25, a first piston 26 for pressing the first clutch plates 25 against each other, and a first hydraulic pressure chamber 26A.

If the first piston 26 is stroked toward an output side (in a right direction in FIG. 1) by an hydraulic pressure supplied to the first hydraulic pressure chamber 26A, the first clutch plates 25 are pressed against each other and thus the first clutch 21 becomes a connecting state where the first clutch 21 transmits a torque. On the other hand, if the hydraulic pressure of the first hydraulic pressure chamber 26A is released, the first piston 26 is stroked toward an input side (in a left direction in FIG. 1) by an urging force of a spring (not shown), and the first clutch 21 becomes a disconnecting state where the first clutch 21 blocks a power transmission.

The second clutch 22 is, for example, a wet multi-plate clutch and includes a clutch hub 23; a second clutch drum 27 integrally rotating with a second input shaft 32 of the transmission mechanism 30; a plurality of second clutch plates 28; a second piston 29 for pressing the second clutch plates 28 against each other; and a second hydraulic pressure chamber 29A.

If the second piston 29 is stroked toward the output side (in the right direction in FIG. 1) by an hydraulic pressure supplied to the second hydraulic pressure chamber 29A, the second clutch plates 28 are pressed against each other and thus the second clutch 22 becomes a connecting state where the second clutch 22 transmits a torque. On the other hand, if the hydraulic pressure is released, the second piston 29 is stroked toward the input side (in the left direction in FIG. 1) by an urging force of a spring (not shown), the second clutch 22 becomes a disconnecting state where the second clutch 22 blocks a power transmission.

The transmission mechanism 30 includes a subsidiary transmission 40 arranged on the input side and a main transmission 50 arranged on the output side. Also, the transmission mechanism 30 includes first and second input shafts 31, 32 provided in the subsidiary transmission 40, an output shaft 33 provided in the main transmission 50, and a subsidiary shaft 34 arranged parallel to the shafts 31 to 33. The first input shaft 31 is relatively rotatably inserted in a hollow shaft extending through the second input shaft 32 in an axial direction thereof. An output end of the output shaft 33 is connected to a propeller shaft, which is connected to vehicle driving wheels via a differential device and the like (all not shown).

The subsidiary transmission 40 is provided with a first primary gear train 41 for low speed and a second primary gear train 42 for high speed. The first primary gear train 41 has a first input main gear 43 fixed on the first input shaft 31, and a first input subsidiary gear 44 fixed on the subsidiary shaft 34 and normally engaged with the first input main gear 43. The second primary gear train 42 has a second input main gear 45 fixed on the second input shaft 32, and a second input subsidiary gear 46 fixed on the subsidiary shaft 34 and normally engaged with the second input main gear 45. Setting of gear ratios of the first and second primary gear trains 41, 42 will be described later.

The main transmission 50 is provided with a ½ stage gear train 51, a ¾ stage gear train 52, a ⅚ stage gear train 53 and a reverse gear train 54, which correspond to respective gear-shift stages, and also provided with a plurality of synchronization mechanisms 60 for selectively synchronously joining these gear-shifting gear trains 51 to 54 with the output shaft 33.

The ½ stage gear train 51 has a ½ stage subsidiary gear 51A fixed on the subsidiary shaft 34, and a ½ stage main gear 51B relatively rotatably provided on the output shaft 33 and normally engaged with the ½ stage subsidiary gear 51A.

The ¾ stage gear train 52 has a ¾ stage subsidiary gear 52A fixed on the subsidiary shaft 34, and a ¾ stage main gear 52B relatively rotatably provided on the output shaft 33 and normally engaged with the ¾ stage subsidiary gear 52A.

The ⅚ stage gear train 53 has a ⅚ stage subsidiary gear 53A fixed on the subsidiary shaft 34, and a ⅚ stage main gear 53B relatively rotatably provided on the output shaft 33 and normally engaged with the ⅚ stage subsidiary gear 53A.

The reverse gear train 54 has a reverse subsidiary gear 54A fixed on the subsidiary shaft 34, a reverse main gear 54B relatively rotatably provided on the output shaft 33, and an idler gear 54C normally engaged with the gears 55A, 55B.

Each of the synchronization mechanisms 60 has a known structure and includes a synchronization sleeve, a synchronization ring and the like (all not shown). Operation of each of the synchronization mechanisms 60 is controlled by a control unit 80 depending on the rotation speed of the engine, a vehicle speed and the like, thereby selectively synchronously joining the output shaft 33 with each of the gear-shift main gears 51B to 54B.

Next, the detailed setting of gear ratios of the dual-clutch automatic transmission according to the present embodiment will be described. Numerical values used in the following description are examples of the present embodiment and thus can be properly set to optimal values within a range without departing from the spirit and scope of the present invention.

One example of the numbers of gear teeth and gear ratios of the gear trains of the present embodiment are shown in the following Table 1, and final gear ratios of gear-shift stages 1 to 6 and step ratios upon gear shifts thereof are shown in the following Table 2. The numbers of gear teeth and gear ratios of gear trains of a conventional example are shown in the following Table 3, and final gear ratios of gear-shift stages 1 to 6 and step ratios upon gear shifts thereof are shown in the following Table 4. In Tables 1 and 3, the numbers of teeth Z1 represent the numbers of teeth of gears provided on the subsidiary shaft, and the numbers of teeth Z2 represent the numbers of teeth of gears provided on the input shaft or the output shaft.

TABLE 1

| | First | Second | | | |
|---|---|---|---|---|---|
| | Primary | Primary | 1st/2nd | 3rd/4th | 5th/6th |
| The Number of | 28 | 35 | 13 | 21 | 38 |
| Teeth Z1 | | | | | |
| The Number of | 45 | 38 | 43 | 37 | 35 |
| Teeth Z2 | | | | | |
| Gear Ratio | 1.61 | 1.09 | 3.31 | 1.76 | 0.92 |

TABLE 2

| | 1st | 2nd | 3rd | 4th | 5th | 6th |
|---|---|---|---|---|---|---|
| Transmission | 5.32 | 3.59 | 2.83 | 1.91 | 1.48 | 1.00 |
| Ratio | | | | | | |

| | | | | | |
|---|---|---|---|---|---|
| Step Ratio | 1.48 | 1.27 | 1.48 | 1.29 | 1.48 |

TABLE 3

| | First | Second | | | |
|---|---|---|---|---|---|
| | Primary | Primary | 1st/2nd | 3rd/4th | 5th/6th |
| The Number of | 28 | 34 | 13 | 21 | 38 |
| Teeth Z1 | | | | | |
| The Number of | 45 | 39 | 43 | 37 | 35 |
| Teeth Z2 | | | | | |
| Gear Ratio | 1.61 | 1.15 | 3.31 | 1.76 | 0.92 |

TABLE 4

| | 1st | 2nd | 3rd | 4th | 5th | 6th |
|---|---|---|---|---|---|---|
| Transmission | 5.32 | 3.79 | 2.83 | 2.02 | 1.48 | 1.06 |
| ratio | | | | | | |

| | | | | | |
|---|---|---|---|---|---|
| Step ratio | 1.48 | 1.34 | 1.40 | 1.37 | 1.40 |

In the conventional example shown in Tables 3 and 4, an interstage ratio of the subsidiary transmission obtained by dividing a gear ratio of the first primary gear train by a gear ratio of the second primary gear train is approximately 1.40 (=1.61/1.15). If the interstage ratio of the subsidiary transmission is set to such a value, the step ratios upon gear shifts are set to have approximately the same and equal intervals as shown in Table 4. Also, as shown in FIG. 3, differences in the number of revolutions between the input side and the output side upon upshifting are approximately the same between gear shifts from the odd-numbered stage to the even-numbered stage (1st→2nd, 3rd→4th, 5th→6th), which are performed by only clutch change, and gear shifts from the even-numbered stage to the odd-numbered stage (2nd→3rd, 4th→5th), which are performed by both clutch change and gear change.

As a result, in the conventional example, a time required for gear shifts performed by both clutch change and gear change is longer than a time required for gear shifts performed by only clutch change due to an influence of rotational synchronous joining. There is a problem that a sense of incompatibility is given to a driver, thereby worsening the gear-shift feeling.

On the other hand, in the present embodiment shown in Tables 1 and 2, the interstage ratio of the subsidiary transmission is set to approximately 1.48(=1.61/1.09), which is greater than the interstage ratio in the above conventional example. If the interstage ratio of the subsidiary transmission is set to such a value, step ratios upon gear shifts from the odd-numbered stage to the even-numbered stage (1st→2nd, 3rd→4th, 5th→6th), which are performed by only clutch change, are set to be smaller than steps ratios upon gear shifts from the even-numbered stage to the odd-numbered stage (2nd→3rd, 4th→5th), which are performed by both clutch change and gear change.

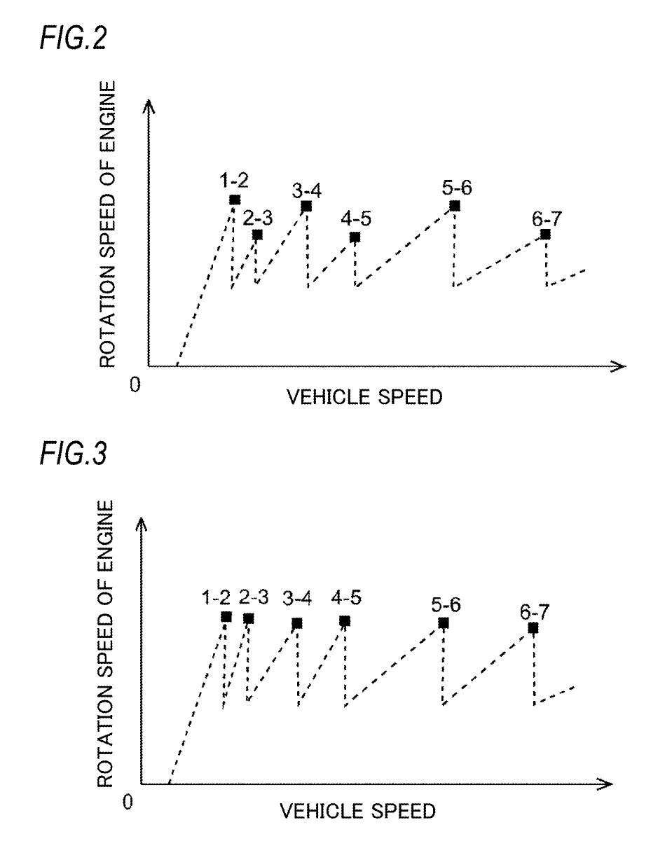

As a result, as shown in FIG. 2, differences in the number of revolutions between the input side and the output shaft upon upshifting are suppressed such that differences in the number of revolutions upon gear shifts from the even-numbered stage to the odd-numbered stage (2nd→3rd, 4th→5th), which are performed by both clutch change and gear change, are smaller than differences in the number of revolutions upon gear shifts from the odd-numbered stage to the even-numbered stage (1st→2nd, 3rd→4th, 5th→6th), which are performed by only clutch change, thereby reducing a time required for synchronous joining. That is, a time required for gear shifts performed by both clutch change and gear change becomes shorter than that of the conventional example, so as to be approximately the same as a time required for gear shifts performed by only clutch change, thereby effectively reducing a sense of incompatibility, which would have been given to a driver upon upshifting.

As described in detail in the foregoing, the interstage ratio of the subsidiary transmission in the present embodiment is set to be larger than that of the conventional example, in which the step ratios upon gear shifts are approximately the same, so that step ratios upon gear shifts performed by both clutch change and gear change are set to be smaller than step ratios upon gear shifts performed by only clutch change. As a result, differences in the number of revolutions between the input side and the output side upon upshifting are suppressed such that differences in the number of revolutions upon gear shifts performed by both clutch change and gear change are smaller than differences in the number of revolutions upon gear shifts performed by only clutch change, thereby reducing a time required for synchronous joining upon gear change. Therefore, the time required for gear shifts performed by only clutch change and the time required for gear shifts performed by both clutch change and gear change are approximately the same, so that unevenness in time required for gear shifts is suppressed, thereby effectively reducing a sense of incompatibility, which would have been given to a driver upon upshifting, and thus reliably enhancing the gear-shift feeling.

The present invention is not limited to the foregoing embodiments, and accordingly, appropriate changes can be made thereto without departing from the spirit and scope of the present invention.

For example, setting of gear ratios is not limited to the foregoing embodiments, but the gear ratios may be properly set to optimal values within a range, in which step ratios upon gear shifts performed by both clutch change and gear change is small relative to step ratios upon gear shifts performed by only clutch change.

Also, arrangement of gears, the number of gear-shift stages and the like are not limited to the shown example, but the present invention can be widely applied to dual-clutch transmissions having any other arrangements and numbers of gear-shift stages.

This application is based on Japanese Patent Application No. 2015-222047 filed on Nov. 12, 2015, the entire contents of which are incorporated herein by reference.

### INDUSTRIAL APPLICABILITY

The dual-clutch transmission according to the present disclosure exhibits the effect that unevenness in time required for gear shifts can be suppressed so as to effectively reduce a sense of incompatibility, which would have been given to a driver, and thus is useful in that it can be contribute to realization of a vehicle having a comfortable driving feeling.

### REFERENCE NUMERALS LIST

10: Engine
20: Dual-clutch device
21: First clutch
22: Second clutch
30: Transmission mechanism
31: First input shaft
32: Second input shaft
33: Output shaft
34: Subsidiary shaft
40: Subsidiary transmission
41: First primary gear train
42: Second primary gear train
50: Main transmission
51: ½ stage gear train
52: ¾ stage gear train
53: ⅚ stage gear train
54: Reverse gear train
60: Synchronization mechanism
80: Control unit
90: Sensor of rotation speed of engine
95: Vehicle speed sensor

1. A dual-clutch transmission, comprising:
a clutch device having first and second clutches capable of connecting or disconnecting power from a driving source;
a first input shaft connected to the first clutch;
a second input shaft connected to the second clutch;
a subsidiary shaft arranged parallel to the first and second input shafts;
an output shaft arranged parallel to the subsidiary shaft;
a first primary gear train that transmits power from the first input shaft to the subsidiary shaft;
a secondary primary gear train that transmits power from the second input shaft to the subsidiary shaft;
a plurality of output gear trains rotatably provided on at least one of the subsidiary shaft or the output shaft; and
a synchronization mechanism for synchronously joining the output gear trains;
wherein a first gear-shift stage is set when the first clutch is in a connecting state and the second clutch is in a disconnecting state by the clutch device in a state where one of the output gear trains is synchronously joined by the synchronization mechanism,
wherein an upshifting to a second gear-shift stage, which is one stage higher than the first gear-shift stage, is performed when the first clutch is changed to a disconnecting state and the second clutch is changed to a connecting state by the clutch device in a state where the one of the output gear trains is synchronously joined by the synchronization mechanism,
wherein an upshifting to a third gear-shift stage, which is one stage higher than the second gear-shift stage, is performed when the first clutch is changed to the connecting state and the second clutch is changed to the disconnecting state by the clutch device in a state where another output gear train different from the one of the output gear trains is synchronously joined by the synchronization mechanism, and
wherein a step ratio upon gear shift from the second gear-shift stage to the third gear-shift stage is set to be smaller than a step ratio upon gear shift from the first gear-shift stage to the second gear-shift stage.

2. The dual-clutch transmission according to claim 1, wherein an interstage ratio obtained by dividing a gear ratio of the first primary gear train by a gear ratio of the second primary gear train is set to be larger than an interstage ratio which causes step ratios upon gear shifts to become the same.
